(19) United States
(12) Patent Application Publication
(10) Pub. No.: US 2026/0074766 A1
(43) Pub. Date: Mar. 12, 2026

(54) PRECODER PREDICTION FOR SCELL USING PCELL CSI

(71) Applicant: Samsung Electronics Co., Ltd., Suwon-si (KR)

(72) Inventors: Rajesh Kumar Mishra, Dallas, TX (US); Fan Zhang, Plano, TX (US); Yeqing Hu, Allen, TX (US); Yang Li, Plano, TX (US)

(21) Appl. No.: 19/315,419

(22) Filed: Aug. 29, 2025

Related U.S. Application Data
(60) Provisional application No. 63/691,954, filed on Sep. 6, 2024.

(51) Int. Cl. H04B 7/06; H04B 17/318; H04L 5/00

(52) U.S. Cl. CPC H04B 7/0639; H04B 7/0626; H04B 7/0632; H04B 17/328; H04L 5/0044

(57) ABSTRACT

Apparatuses and methods for a precoder prediction for SCell using a PCell CSI in a wireless communication system. A method of a BS in a wireless communication system includes: receiving an uplink (UL) sounding reference signal (SRS) on a primary cell (PCell); identifying, based on the UL SRS, spatial information associated with a frequency within a center frequency gap between a UL and a downlink (DL); identifying, based on the spatial information, one or more wideband (WB) precoders for at least one user equipment (UE) camping in a secondary cell (SCell); and transmitting, to the UE, a signal based on the one or more WB precoders.

### CROSS-REFERENCE TO RELATED APPLICATIONS AND CLAIM OF PRIORITY

The present application claims priority to U.S. Provisional Patent Application No. 63/691,954, filed on Sep. 6, 2024. The contents of the above-identified patent documents are incorporated herein by reference.

### TECHNICAL FIELD

The present disclosure relates generally to wireless communication systems and, more specifically, the present disclosure relates to precoder prediction for secondary cell (SCell) using a primary cell (PCell) channel state information (CSI) in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to a precoder prediction for SCell using a PCell CSI in a wireless communication system.

In one embodiment, a base station (BS) in a wireless communication system is provided. The BS comprises a transceiver configured to receive an uplink (UL) sounding reference signal (SRS) on a PCell. The BS further comprises a processor operably coupled to the transceiver, the processor configured to: identify, based on the UL SRS, spatial information associated with a frequency within a center frequency gap between a UL and a downlink (DL), and identify, based on the spatial information, one or more wideband (WB) precoders for at least one user equipment (UE) camping in a SCell, wherein the transceiver is further configured to transmit, to the UE, a signal based on the one or more WB precoders.

In another embodiment, a method of a BS in a wireless communication system is provided. The method comprises receiving a UL SRS on a PCell; identifying, based on the UL SRS, spatial information associated with a frequency within a center frequency gap between a UL and a DL; identifying, based on the spatial information, one or more WB precoders for at least one UE camping in a SCell; and transmitting, to the UE, a signal based on the one or more WB precoders.

In yet another embodiment, a non-transitory computer-readable medium comprising program code, that when executed by at least one processor, causes an electronic device to: receive a UL SRS on a PCell; identify, based on the UL SRS, spatial information associated with a frequency within a center frequency gap between a UL and a DL; identify, based on the spatial information, one or more WB precoders for at least one UE camping in a SCell; and transmit, to the UE, a signal based on the one or more WB precoders.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate examples of wireless transmit and receive paths according to this disclosure;

FIG. 6 illustrates an example of PCell and SCell channel frequency bands according to embodiments of the present disclosure;

FIG. 7 illustrates an example of SCell precoder computation from the PCell channel according to embodiments of the present disclosure;

FIG. 8 illustrates an example of throughput analysis according to embodiments of the present disclosure; and

FIG. 9 illustrates a flowchart of method for a precoder prediction for SCell using a PCell CSI in a wireless communication system according to embodiments of the present disclosure.

### DETAILED DESCRIPTION

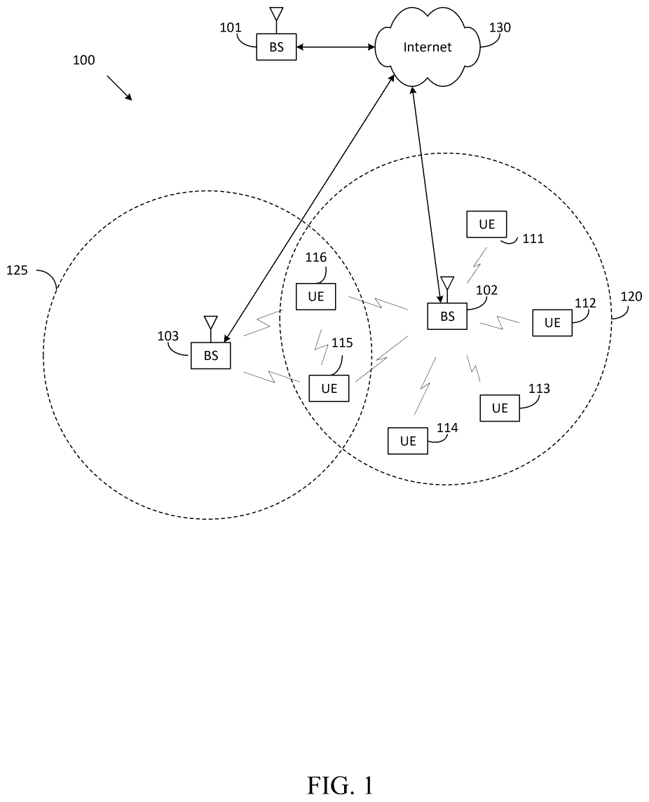

FIGS. 1-9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 36.211 v16.4.0, “E-UTRA, Physical channels and modulation”; 3GPP TS 36.212 v16.4.0, “E-UTRA, Multiplexing and Channel coding”; 3GPP TS 36.213 v16.4.0, “E-UTRA, Physical Layer Procedures”; 3GPP TS 36.321 v16.3.0, “E-UTRA, Medium Access Control (MAC) protocol specification”; 3GPP TS 36.331 v16.3.0, “E-UTRA, Radio Resource Control (RRC) Protocol Specification”; 3GPP TS 38.211 v16.4.0, “NR, Physical channels and modulation”; 3GPP TS 38.212 v16.4.0, “NR, Multiplexing and Channel coding”; 3GPP TS 38.213 v16.4.0, “NR, Physical Layer Procedures for Control”; 3GPP TS 38.214 v16.4.0, “NR, Physical Layer Procedures for Data”; 3GPP TS 38.215 v16.4.0, “NR, Physical Layer Measurements”; 3GPP TS 38.321 v16.3.0, “NR, Medium Access Control (MAC) protocol specification”; and 3GPP TS 38.331 v16.3.1, “NR, Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered as a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for an operation for precoder prediction for SCell using a PCell CSI in a wireless communication system. In certain embodiments, and one or more of the gNBs 101-103 includes circuitry, programing, or a combination thereof, for precoder prediction for SCell using a PCell CSI in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

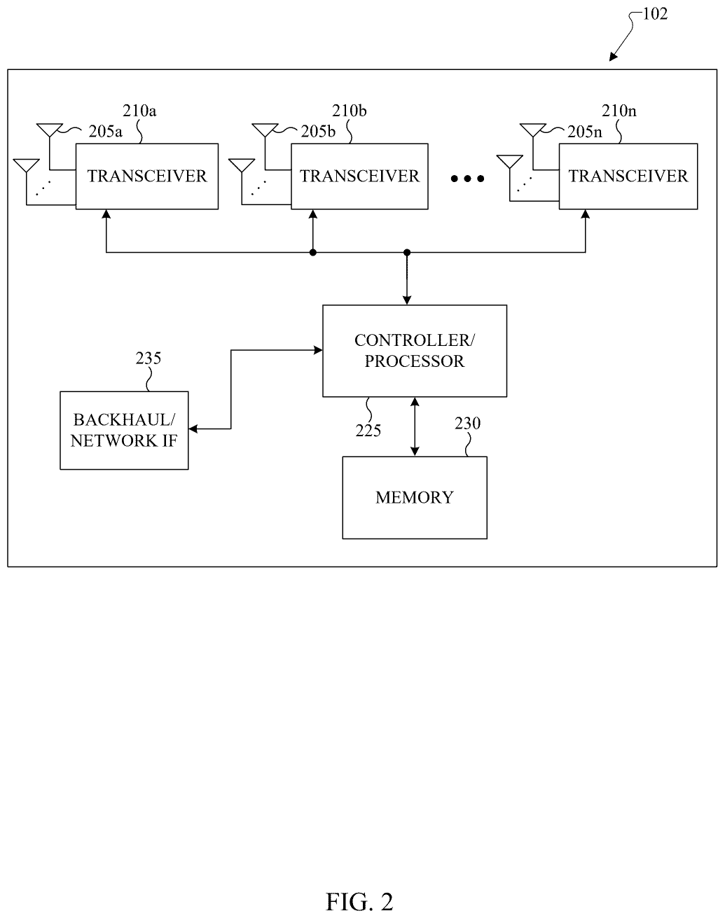

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for precoder prediction for SCell using a PCell CSI in a wireless communication system. The controller/processor 225 can move data into or out of the memory 230 as performed by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

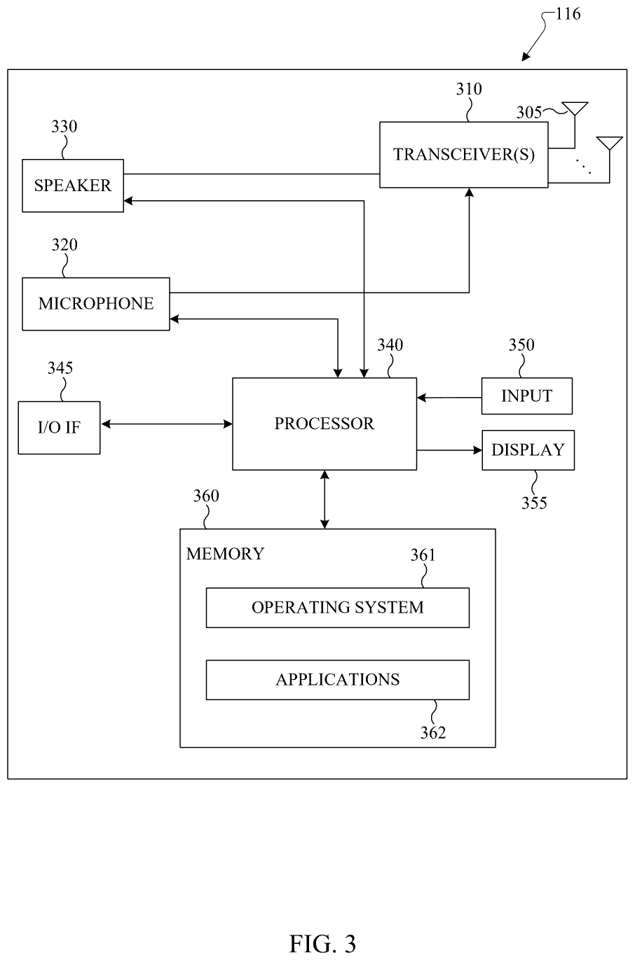

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for supporting an operation of precoder prediction for SCell using a PCell CSI in a wireless communication system.

The processor 340 can move data into or out of the memory 360 as performed by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

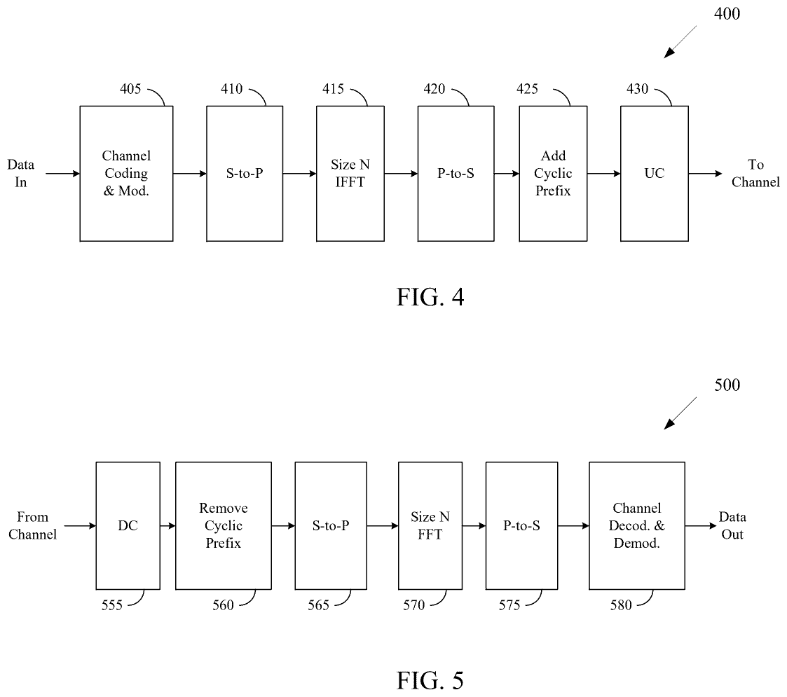

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In various embodiments, the receive path 500 can be implemented in a first UE and the transmit path 400 can be implemented in a second UE. In some embodiments, the transmit path 400 is configured to utilize a precoder prediction for SCell using a PCell CSI in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

In 5G NR systems, the data throughput can be augmented by using contiguous frequency bands, a SCell along with a PCell, to increase the total operating bandwidth. The precoders for the SCell are either obtained as a PMI feedback from a UE or are computed at the base station from the channel state measured at its side. In some embodiments, the disclosed technology includes using the CSI obtained from the PCell's sounding reference signal (SRS) to predict the precoders for data transmission in the SCell.

In the present disclosure, some embodiments provide an electronic device and method on a calibration mechanism for (distributed) multi-input multi-output (MIMO) operations, more particularly, to the electronic device and method on a UE-assisted calibration mechanism in (distributed) MIMO of wireless networks.

In 5G NR systems, an SCell is used along with the PCell to augment the data throughput. However, the precoders for the SCell are obtained as a PMI feedback from the UE which is not very efficient. Obtaining the CSI at the base station using UL SRS on the SCell is also expensive. A goal is therefore, to devise a technique to obtain the CSI for the SCell and use the CSI to compute the precoders.

In one embodiment, the UL SRS obtained from the PCell is used to derive spatial information which are invariable to the frequency translation in a broader sense and then use the spatial information to compute wideband (WB) precoders for the users in the SCell.

Although this disclosure may relate to 3GPP 5G NR communication systems, various embodiments may apply in general to UEs operating with other RATs and/or standards, such as different releases/generations of 3GPP standards (including beyond 5G, 6G, and so on), IEEE standards (such as 802.16 WiMAX and 802.11 Wi-Fi), and so on.

In one embodiment, a single user-MIMO (SU-MIMO) system where a base station with N_{Tx} antennas is intending to transmit data to UE with N_{Rx} antennas is provided. The received signal at the UE is given as: y=HPx+N where y ∈ [symbol] ^{NRx×1} is the received signal, Hᵢ ∈ C^{NRx×NTx} is the channel on i^{th} RB, i ∈ [1, N_{RB}] is between the base station and the UE, N_{RB} is the number of the RBs, P ∈ C^{NTx×r} is the wideband precoders common across all RBs for the user, x ∈ C^{r×1}, r is the rank of the transmission and N ∈ C^{NRx×1} is the Gaussian noise with noise variance σ².

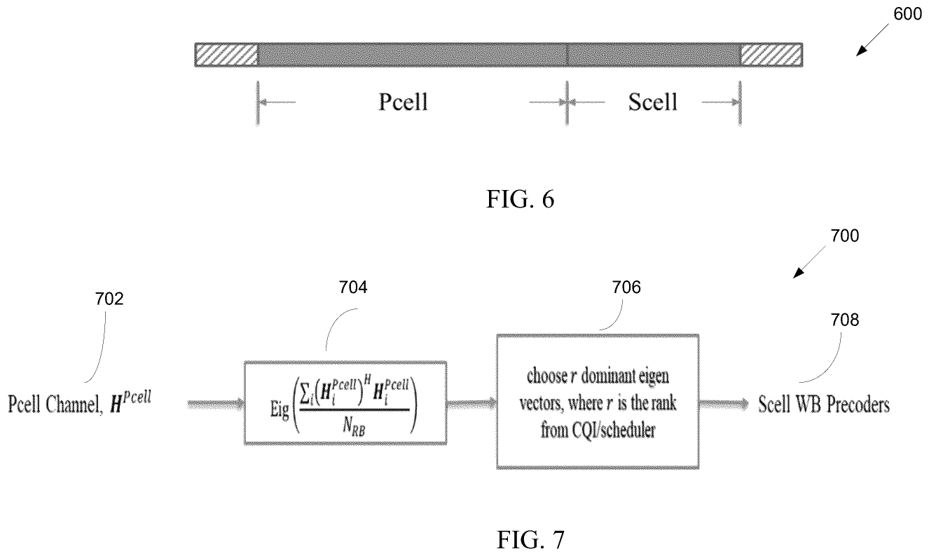

The two different contiguous operating frequency bands are used for channel transmission between the BS and the UE: the PCell and the SCell channels as shown in FIG. 6.

FIG. 6 illustrates an example of PCell and SCell channel frequency bands 600 according to embodiments of the present disclosure. An embodiment of the PCell and SCell channel frequency bands 600 shown in FIG. 6 is for illustration only.

In one embodiment, the precoder for the SCell is computed from the CSI received on the SCell. It can be assumed that the angle delay profile does not change over the different bands.

The precoder computation for sum capacity maximization given a channel CSI, H, is given

$$as {P}^{*} = {argmax}_{p} {Σ}_{i} {log}_{2} det ( {I}_{{N}_{Rx}} + \frac{{P}^{H} {H}_{i}^{H} {H}_{i} P}{{σ}^{2}} ) \approx {argmax}_{p} {log}_{2} det ( {I}_{{N}_{Rx}} + {Σ}_{i} \frac{{P}^{H} {H}_{i}^{H} {H}_{i} P}{{σ}^{2}} ) .$$

The optimal precoders P* can be computed to be the dominant Eigen vectors of the channel covariance matrix

$$R = \frac{{Σ}_{i} {H}_{i}^{H} {H}_{i}}{{N}_{RB}} \approx E [ {H}_{i}^{H} {H}_{i} ]$$

for large number of RBs. The dominant eigen vectors capture the spatial information as the frequency information is averaged out. The spatial information remains similar across the SCell and PCell. Therefore, the precoders determined from the PCell channel are then applied for transmission in the SCell.

In one embodiment, the rank of the transmission for the SCell is determined from the channel quality indicator (CQI) feedback. The final precoders P ∈ [symbol] ^{NTx×r} are the first r dominant eigen vectors from the eigen value decomposition of the channel covariance matrix as articulated above. The full process of determination of the SCell precoders have been represented in FIG. 7.

FIG. 7 illustrates an example of SCell precoder computation 700 from the PCell channel according to embodiments of the present disclosure. An embodiment of the SCell precoder computation 700 shown in FIG. 7 is for illustration only.

As illustrated in FIG. 7, in step 702, the channel capacity is identified on PCell channel. In step 704, eigen values are determined. In step 706, dominant eigen vectors are identified.

In one embodiment, a simple user classification is provided based on the received reference signal received power (RSRP) of the UEs, to determine whether the use of wideband precoders from PCell CSI may be beneficial against the wideband PMI feedback obtained from the UE.

The received RSRP at the UEs is a measure of the quality of the channel and it is also quantity reported by the UE to the base station. In one embodiment, this value (e.g., quality of channel reported to the base station) to determine the applicability of our wideband precoders. Basically, there is a threshold (=γ_{RSRP}) such that if the reported RSRP>γ_{RSRP}, then the SCell precoders determined from the PCell channel may be used otherwise the wideband PMI precoders are used.

From the network side, when the RSRP feedback is not available from the UE, one indicator of the RSRP is the PCell SRS signa to noise ratio (SNR). The BS can select the UE that benefit from PCell CSI prediction from a certain SNR range. FIG. 3 illustrates that, in low SNR, the PCell SRS is not reliable, such that WB precoder will show loss, and, in very high SNR, the UE has very good DL SNR, such that the gain of using WB precoder to PMI is not significant.

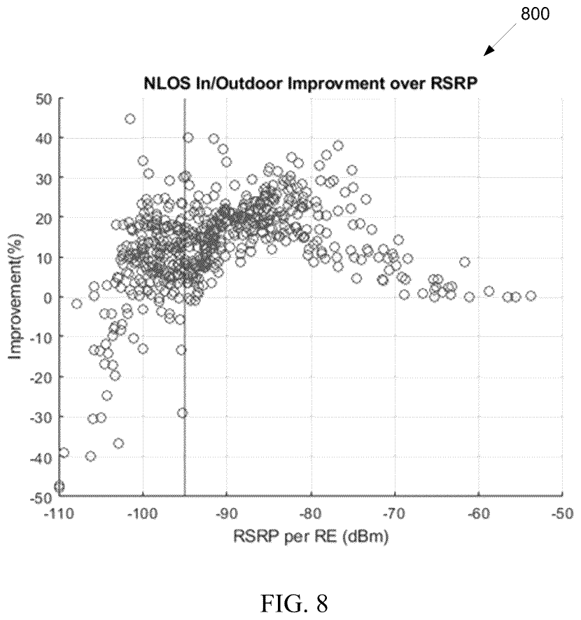

FIG. 8 illustrates an example of throughput analysis 800 according to embodiments of the present disclosure. An embodiment of the throughput analysis 800 shown in FIG. 8 is for illustration

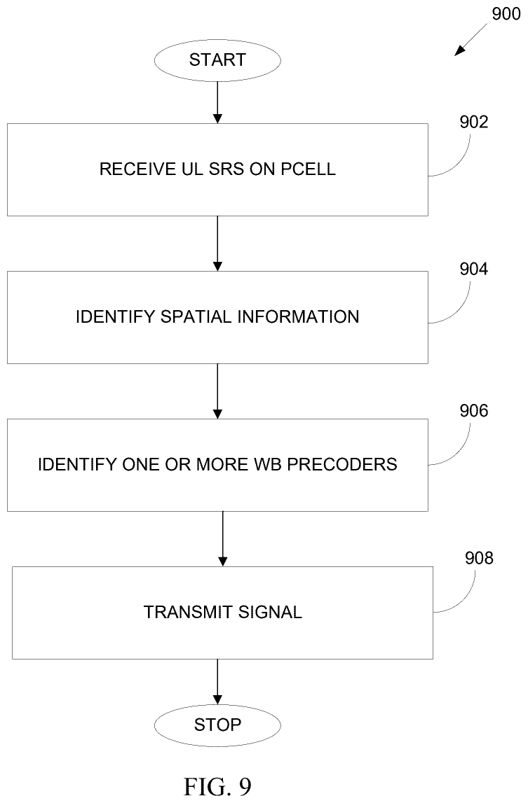

FIG. 9 illustrates a flowchart of method 900 for precoder prediction for SCell using a PCell CSI in a wireless communication system according to embodiments of the present disclosure. The method 900 may be performed by a BS (e.g., 101-103 as illustrated in FIG. 1). An embodiment of the method 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

As illustrated in FIG. 9, the method 900 begins at step 902. In step 902, a BS receives a UL SRS on a PCell.

Subsequently, in step 904, the BS identifies, based on the UL SRS, spatial information associated with a frequency within a center frequency gap between a UL and a DL.

Next, in step 906, the BS identifies, based on the spatial information, one or more WB precoders for at least one UE camping in a SCell.

Finally, in step 908, the BS transmits, to the UE, a signal based on the one or more WB precoders.

In one embodiment, the BS classifies, based on an RSRP, the at least one UE to apply the one or more WB precoders.

In one embodiment, the BS identifies a function of an SNR of the UL SRS.

In one embodiment, the BS determines, based on the function of the SNR of the UL SRS, whether to apply the one or more WB precoders for the at least one UE in accordance with a classification of the at least one UE.

In one embodiment, the BS receives, from the at least one UE, information associated with an RSRP.

In one embodiment, the BS identifies a covariance expectation value based on the SRS of PCell to determine dominant eigen vectors of a channel covariance matrix for RBs.

In one embodiment, the BS identifies, based on the covariance matrix of the SRS, eigen vectors of the PCell.

In such embodiments, a number of the dominant eigen vectors to be used for the DL is identified based on reported rank and a CQI for generating the one or more WB precoders for the SCell.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A base station (BS) in a wireless communication system, the BS comprising:
a transceiver configured to receive an uplink (UL) sounding reference signal (SRS) on a primary cell (PCell); and
a processor operably coupled to the transceiver, the processor configured to:
identify, based on the UL SRS, spatial information associated with a frequency within a center frequency gap between a UL and a downlink (DL), and
identify, based on the spatial information, one or more wideband (WB) precoders for at least one user equipment (UE) camping in a secondary cell (SCell),
wherein the transceiver is further configured to transmit, to the UE, a signal based on the one or more WB precoders.

2. The BS of claim 1, wherein the processor is further configured to classify, based on a reference signal received power (RSRP), the at least one UE to apply the one or more WB precoders.

3. The BS of claim 2, wherein the processor is further configured to:
identify a function of a signal-to-noise ratio (SNR) of the UL SRS; and
determine, based on the function of the SNR of the UL SRS, whether to apply the one or more WB precoders for the at least one UE in accordance with a classification of the at least one UE.

4. The BS of claim 1, wherein the transceiver is further configured to receive, from the at least one UE, information associated with a reference signal received power (RSRP).

5. The BS of claim 1, wherein the processor is further configured to identify a covariance expectation value based on the SRS of PCell to determine dominant eigen vectors of a channel covariance matrix for resource blocks (RBs).

6. The BS of claim 5, wherein the processor is further configured to identify, based on a covariance matrix of the SRS, eigen vectors of the PCell.

7. The BS of claim 5, wherein a number of the dominant eigen vectors to be used for the DL is identified based on reported rank and a channel quality indicator (CQI) for generating the one or more WB precoders for the SCell.

8. A method of a base station (BS) in a wireless communication system, the method comprising:
receiving an uplink (UL) sounding reference signal (SRS) on a primary cell (PCell);
identifying, based on the UL SRS, spatial information associated with a frequency within a center frequency gap between a UL and a downlink (DL);
identifying, based on the spatial information, one or more wideband (WB) precoders for at least one user equipment (UE) camping in a secondary cell (SCell); and
transmitting, to the UE, a signal based on the one or more WB precoders.

9. The method of claim 8, further comprising classifying, based on a reference signal received power (RSRP), the at least one UE to apply the one or more WB precoders.

10. The method of claim 9, further comprising:
identifying a function of a signal-to-noise ratio (SNR) of the UL SRS; and
determining, based on the function of the SNR of the UL SRS, whether to apply the one or more WB precoders for the at least one UE in accordance with a classification of the at least one UE.

11. The method of claim 8, further comprising receiving, from the at least one UE, information associated with a reference signal received power (RSRP).

12. The method of claim 8, further comprising identifying a covariance expectation value based on the SRS of PCell to determine dominant eigen vectors of a channel covariance matrix for resource blocks (RBs).

13. The method of claim 12, further comprising identifying, based on a covariance matrix of the SRS, eigen vectors of the PCell.

14. The method of claim 12, wherein a number of the dominant eigen vectors to be used for the DL is identified based on reported rank and a channel quality indicator (CQI) for generating the one or more WB precoders for the SCell.

15. A non-transitory computer-readable medium comprising program code, that when executed by at least one processor, causes an electronic device to:
receive an uplink (UL) sounding reference signal (SRS) on a primary cell (PCell);
identify, based on the UL SRS, spatial information associated with a frequency within a center frequency gap between a UL and a downlink (DL);
identify, based on the spatial information, one or more wideband (WB) precoders for at least one user equipment (UE) camping in a secondary cell (SCell); and
transmit, to the UE, a signal based on the one or more WB precoders.

16. The non-transitory computer-readable medium of claim 15, further comprising program code, that when executed by at least one processor, causes an electronic device to classify, based on a reference signal received power (RSRP), the at least one UE to apply the one or more WB precoders.

17. The non-transitory computer-readable medium of claim 16, further comprising program code, that when executed by at least one processor, causes an electronic device to:
identify a function of a signal-to-noise ratio (SNR) of the UL SRS; and
determine, based on the function of the SNR of the UL SRS, whether to apply the one or more WB precoders for the at least one UE in accordance with a classification of the at least one UE.

18. The non-transitory computer-readable medium of claim 15, further comprising program code, that when executed by at least one processor, causes an electronic device to receive, from the at least one UE, information associated with a reference signal received power (RSRP).

19. The non-transitory computer-readable medium of claim 15, further comprising program code, that when executed by at least one processor, causes an electronic device to identify a covariance expectation value based on the SRS of PCell to determine dominant eigen vectors of a channel covariance matrix for resource blocks (RBs).

20. The non-transitory computer-readable medium of claim 19, further comprising program code, that when executed by at least one processor, causes an electronic device to identify, based on a covariance matrix of the SRS, eigen vectors of the PCell,
wherein a number of the dominant eigen vectors to be used for the DL is identified based on reported rank and a channel quality indicator (CQI) for generating the one or more WB precoders for the SCell.
